(19) United States
(12) Patent Application Publication
(10) Pub. No.: US 2005/0112310 A1
(43) Pub. Date: May 26, 2005

(54) Multi-layer laminated channel with interconnected metal and plastic layers and method of fabricating same

(76) Inventors: Sean P. Asiala, Fort Wayne, IN (US); Louis J. Matrisciano, Leo, IN (US)

Correspondence Address: George Pappas, Suite 300, 919 S. Harrison Street, Fort Wayne, IN, 46802, US

(21) Appl. No.: 10/721,810

(22) Filed: Nov. 25, 2003

(51) Int. Cl. B32B 1/08

(52) U.S. Cl. 428/36.9

(57) ABSTRACT

A laminated channel including an inner metal layer and outer plastic layers, preferably ultra high molecular weight polyethylene, adjacent opposite surfaces of the metal layer. The plastic layers are joined to one another with plastic portions extending through holes in the metal layer and at the metal layer perimeter longitudinal edges and end edges. Preferably, the plastic layers are molded around the metal layer thereby integrally forming the plastic portions extending through the holes and the plastic edge portions, and thereby also joining the plastic layers to one another with the metal layer therebetween. Preferably, the longitudinal and end edges of the inner metal layer are enclosed by the outer plastic layers and the plastic edge portions. The joined metal and plastic layers are then cold formed or bent together between the longitudinal edges for thereby forming the laminated channel. The plastic portions through the metal holes and the plastic edge portions maintain the outer plastic layers adjacent the metal layer both during and after the bending and forming of the channel.

### TECHNICAL FIELD

The present invention relates generally to the technical field of laminated articles and, more particularly, is directed to a cold formed multi-layer laminated channel having plastic and metal layers fixedly connected to one another and a method of fabricating the same.

### BACKGROUND OF THE INVENTION

It is generally known to make a laminated structure comprised of an inner layer of metal enclosed by opposite outer layers of plastic. Such laminated structure possesses the outer wear and friction characteristics of the plastic and the structural strength of the metal. For example, in Gibson, U.S. Pat. No. 6,112,875, a multi-layer reinforcing strip is disclosed made of an inner layer of metal and outer layers of plastic, namely ultra high molecular weight polyethylene (UHMWPE). The plastic layers are bonded to the metal with an adhesive or by molding the plastic directly onto the steel.

Similarly, Cooper et al., U.S. Pat. No. 4,308,801, discloses embedding a metal reinforcing structure within a plastic polymer such as UHMWPE and thereby forming a wear resistant center plate liner for railway vehicles. The plastic is cast or formed around the reinforcing metal thereby creating a shape generally similar to the reinforcing metal. Separate and different molds are thus required for each desired shape.

In both Gibson and Cooper et al., the multi-layer formed structure is used in the shape which is created after the molding or adhering of the plastic onto the steel. That is, once formed, the multi-layer structure is not cold formed/cold worked such as by break press, roll forming equipment or other suitable bending or forming equipment or hand forming for creating different shapes.

It is desirable to cold form by bending multi-layer composites formed of an inner layer of metal and an outer layer of plastic, particularly UHMWPE plastic, so as to form various shaped channels. In this manner a single mold or other fabrication process can be used to make the lamination which is, thereafter, cold formed or bent into any desired channel shape. The outer layer of UHMWPE provides an exterior surface having exceptional wear and low friction characteristics. The inner metal layer provides structural strength and the needed cold form memory to retain the desired cold formed channel shape after bending. Channels of this character, especially large channels of this character, can be used as troughs to carry gravel, sand, and softer articles like mail, and for lining trucks and trailers and other surfaces and structures requiring good wear and low friction characteristics.

However, cold forming of plastic and metal laminated composites has been found to be most difficult, especially in the case where the plastic material is an ultra-high molecular weight polyethylene (UHMWPE). The plastic and metal layers do not readily bond with one another even when the respective surfaces are roughened and extreme adhesives are used. Upon cold forming, such as by bending to form a channel, the formation of the laminated channel results in compressive forces in the plastic layer on the inside or interior surface of the laminated channel and tensile forces in the plastic layer on the outside or exterior surface of the laminated channel. These forces cause the layers of metal and steel to shift with respect to and separate from one another.

Cold forming of multi-layer metal and plastic composites has previously been accomplished as, for example, disclosed in Kramer, U.S. Pat. No. 4,596,734. In Kramer the plastic layer of UHMWPE is bonded to a metal backing plate with an elastomer layer. The elastomer layer is sufficiently thick so as to provide resiliency to the composite such that stresses created between the metal and plastic during cold forming are absorbed. However, although the elastomer bonding layer achieves the desired result, it is relatively costly. Additionally, the elastomer layer thickness must be increased when cold forming relatively large sheets of metal and plastic composites making the bond relatively difficult and sometimes unreliable.

Accordingly, a need exists for a further innovation which will eliminate the aforementioned drawbacks in the formation of cold formed laminated metal and plastic channels and, more particularly, the fabrication and providing of cold formed metal and UHMWPE channels.

### SUMMARY OF THE INVENTION

It is the principal object of the present invention to overcome the above-discussed drawbacks and disadvantages.

In general, the present invention is directed to a laminated channel including an inner metal layer and outer plastic layers, preferably UHMWPE, adjacent opposite surfaces of the metal layer. The plastic layers are joined to one another with plastic portions extending through holes in the metal layer. The plastic layers are also joined to one another at the metal layer perimeter longitudinal edges and the metal end edges, with plastic edge portions. Preferably, the UHMWPE plastic layers are molded around the metal layer thereby integrally forming the plastic portions extending through the holes and the plastic edge portions, and thereby also joining the plastic layers to one another with the metal layer therebetween. Preferably, the longitudinal and end edges of the inner metal layer are enclosed by the outer plastic layers and the plastic edge portions. The joined metal and plastic layers are then cold formed or bent (as used herein, the terms “cold forming” and “bending” are intended to be one and the same) together between the longitudinal edges for thereby forming the laminated channel. The plastic portions through the metal holes and the plastic edge portions maintain the outer plastic layers adjacent the metal layer both during and after the bending.

Preferably, a plurality of holes are provided through the metal layer between the opposite surfaces and are substantially aligned in a row generally parallel to the longitudinal edges. The longitudinal edges of the inner metal layer preferably have a non-linear configuration which is common and mating with the longitudinal plastic edge portions. Most preferred configurations of the inner metal layer longitudinal edge and the plastic common mating longitudinal edge portion include sinusoidal, square wave and triangular wave shapes.

Preferably, the inner metal layer is stainless steel, although any metal will do so long as it has sufficient strength to maintain the plastic layers in the desired channel shape after bending. Although the metal and plastic layers can be bent in any desired channel shape, preferred are U, tubular, V, and semicircular cross sectional shapes.

Yet more preferably, the inner metal layer opposite end edges extend generally transverse to the longitudinal edges. Generally adjacent each the opposite end edges of the metal layer, a plurality of holes are provided through the metal layer and the outer plastic layers are joined to one another with plastic portions extending through the plurality of holes adjacent the opposite end edges of the metal layer. For forming longer channels, a pair of channels are aligned and joined to one another end to end along their respective end edges. For forming a tubular shaped channel in cross section, a pair of channels are aligned side by side and joined to one another, longitudinal edge to longitudinal edge.

In general, the method of fabricating a laminated channel includes the steps of providing a metal layer having a pair of opposite surfaces, a pair of opposite longitudinal edges, and a pair of opposite end edges extending in a generally transverse relationship to the longitudinal edges. A predetermined pattern of holes is formed in the metal layer in at least one row and wherein the holes are spaced apart from one another in the row and from the longitudinal edges. A plastic material is provided on the opposite surfaces of the metal layer and is formed into plastic layers. The plastic layers have a pair of longitudinal edges disposed adjacent the longitudinal edges of the metal layer and a pair of end edges disposed adjacent the end edges of the metal layer. Portions of the plastic material extends through the holes in the metal layer and along the longitudinal and end edges so as to interconnect the plastic layers to one another and pin the plastic layers to the metal layer at the locations of the holes and at the longitudinal and end edges so that the plastic layers are immovable relative to the metal layer along the row of holes and the perimeter thereof. The channel is formed by bending the metal and plastic layers together between the opposite longitudinal ends so as to provide sides of the laminated channel disposed in an angular relationship relative to one another and the laminated channel with a preselected cross-sectional shape. Preferably, the metal layer is provided with at least another row of holes extending generally parallel to and spaced from one of the end edges thereof for enabling end portions of the plastic layers to be interconnected to one another. The row of holes adjacent the end edge prevents separation of the layers of plastic adjacent the end edges during and after the end to end joining of channels.

As should be appreciated, the lack of bonding and thus the separation that would normally occur between the plastic and metal layers is overcome by providing a desired predetermined pattern of holes in the metal layer prior to the metal layer being encapsulated by the plastic and by also by extending and joining the plastic layers at the perimeter edges of the metal layer. This ensures mechanical fastening or pinning together of the metal and plastic layers at desired locations through the metal layer and at the perimeter longitudinal and end edges. It is noted that, during bending, the metal layer longitudinal edges will separate or move away from the plastic longitudinal edge portions as a result of the differing forces and stresses experienced between the inner and outer layers. However, the non-linear common mating configuration of the metal and plastic longitudinal edges increases the length of contact between the metal and plastic layers at the longitudinal edges thereby retaining the metal and plastic layers aligned and structurally stable.

While the principles of the present invention are particularly beneficial in the fabrication of channels from laminated structures utilizing ultra-high molecular weight polyethylene (UHMWPE) plastic material, they also are believed to be applicable to laminated structures made of other plastic materials.

In one form thereof, the present invention is directed to a laminated channel including an inner metal layer having opposite surfaces and a pair of opposite longitudinal edges; outer plastic layers adjacent each of the opposite surfaces of the inner metal layer, the plastic layers each having a pair of longitudinal edges disposed adjacent the longitudinal edges of the inner metal layer and wherein, at each longitudinal edge of the inner metal layer, the plastic layers longitudinal edges are joined to one another with a plastic edge portion, whereby the longitudinal edges of the inner metal layer are enclosed by the outer plastic layers and the plastic edge portion; and, the inner metal layer and outer plastic layers being bent together between the inner metal longitudinal edges for thereby forming the laminated channel, and wherein the plastic edge portion between the plastic layers longitudinal edges maintain the outer plastic layers adjacent the metal layer during and after the bending.

In one form thereof, the present invention is directed to a laminated channel including an inner metal layer having opposite surfaces, and at least one hole extending through the metal layer between the opposite surfaces; outer plastic layers adjacent each of the opposite surfaces of the inner metal layer, the outer plastic layers joined to one another with a plastic portion extending through the hole in the inner metal layer such that the outer plastic layers are retained adjacent the inner metal layer; and, the inner metal layer and outer plastic layers being bent together for thereby forming the laminated channel and wherein the plastic portion extending through the hole maintains the outer plastic layer adjacent the metal layer during and after the bending.

The present invention is further directed to a laminated channel which comprises: (a) an inner metal layer having a pair of opposite surfaces, a pair of opposite longitudinal edges, a pair of opposite end edges extending in a generally transverse relationship to the longitudinal edges, and a predetermined pattern of holes located in the inner metal layer in at least one row in which the holes are spaced apart from one another in the row and from the longitudinal edges and extend in a generally transverse relationship to the opposite end edges; and (b) outer plastic layers having a pair of longitudinal edges disposed adjacent the longitudinal edges of the inner metal layer and a pair of end edges disposed adjacent the end edges of the inner metal layer, the outer plastic layers being disposed in movably slidable relationship relative to and on the opposite surfaces of the inner metal layer, the outer plastic layers having portions extending through the holes of the row thereof in the inner metal layer such that such portions interconnect the outer plastic layers to one another and pin the outer plastic layers to the inner metal layer at the locations of the holes so that the outer plastic layers are immovable relative to the inner metal layer along the row of holes; (c) the inner metal layer and outer plastic layers being bent together along at least one longitudinal axis extending between the opposite ends of the inner metal layer and outer plastic layers and spaced from and generally parallel to the row of holes and the longitudinal edges of the inner metal layer and outer plastic layers so as to provide the laminated channel with a preselected cross-sectional shape.

The present invention also is directed to a method of fabricating a laminated channel which comprises the steps of: (a) providing a metal layer having a pair of opposite surfaces, a pair of opposite longitudinal edges, and a pair of opposite end edges extending in a generally transverse relationship to the longitudinal edges; (b) forming a predetermined pattern of holes in the metal layer in at least one row thereof in which the holes are spaced apart from one another in the row and from the longitudinal edges and the at least one row of holes extend in a generally transverse relationship to the opposite end edges; (c) providing a plastic material on the opposite surfaces of the metal layer; (d) forming the plastic material into plastic layers on the opposite surfaces of the metal layer such that the plastic layers are disposed in movably slidable relationship along the opposite surfaces of the metal layer and have a pair of longitudinal edges disposed adjacent the longitudinal edges of the metal layer and a pair of end edges disposed adjacent the end edges of the metal layer but also such that portions of the plastic layers extend through the holes of the row thereof in the metal layer so as to interconnect the plastic layers to one another and pin the plastic layers to the metal layer at the locations of the holes so that the plastic layers are immovable relative to the metal layer along the row of holes; and (e) bending the metal and plastic layers together along at least one longitudinal axis extending between the opposite ends of the metal and plastic layers and spaced from and generally parallel to the row of holes and the longitudinal edges of the metal and plastic layers so as to provide sides of the laminated channel disposed in an angular relationship relative to one another and the laminated channel with a preselected cross-sectional shape.

### BRIEF DESCRIPTION OF THE DRAWINGS

The above mentioned and other features and objects of this invention and the manner of obtaining them will become more apparent and the invention itself will be better understood by reference to the following description of embodiment(s) of the invention taken in conjunction with the accompanying drawings wherein:

FIG. 1 is fragmentary plan view of a laminated panel-like structure comprised of an inner metal layer and opposite outer plastic layers showing holes through the inner metal layer allowing mechanical interconnecting and pinning of the outer plastic layers to one another through the holes at selected locations in the inner metal layer as well as at the perimeter of the inner metal layer during a fabrication process of the present invention.

FIG. 2 is a longitudinal sectional view of the laminated structure taken along line 2-2 of FIG. 1, with the respective thicknesses of the layers of the structure being exaggerated for purpose of illustrating the principles of the present invention.

FIG. 3 is a cross-sectional view of the laminated structure taken along line 3-3 of FIG. 1, again with the respective thicknesses of the layers of the structure being exaggerated.

FIG. 4 is a plan view of the inner metal layer of the laminated structure of FIG. 1 showing a predetermined pattern of holes at the selected locations for forming a cross-sectionally U-shaped channel and also showing longitudinal edges having sinusoidal shapes.

FIG. 5 is a cross-sectional view of a U-shaped channel showing one of the holes of the predetermined pattern of holes provided in the inner metal layer for facilitating formation of the U-shaped channel by the fabrication process, again with the respective thicknesses of the layers of the channel being exaggerated.

FIG. 6 is a cross-sectional view of a semicircular-shaped channel showing the predetermined pattern of holes in the inner metal layer for facilitating formation of the semicircular-shaped channel by the fabrication process, again with the respective thicknesses of the layers of the channel being exaggerated.

FIG. 7 is a cross-sectional view of a tubular shaped channel showing the holes of the predetermined pattern of holes in the inner metal layer for facilitating formation of the tubular shaped channel by the fabrication process, again with the respective thicknesses of the layers of the channel being exaggerated.

FIG. 8 is a fragmentary view of an alternate metal layer longitudinal edge having an alternate square wave shape.

FIG. 9 is a fragmentary view of an alternate metal layer longitudinal edge having an alternate triangular wave shape.

FIG. 10 is a block diagram of the laminated channel fabrication process of the present invention.

FIG. 11 is a plan view of two laminated structures constructed in accordance with the principals of the present invention and joined to end-to-end to form and longer channel.

Corresponding reference characters indicate corresponding parts throughout the several views of the drawings.

The exemplifications set out herein illustrate preferred embodiments of the invention in one form thereof and such exemplifications are not to be construed as limiting the scope of the disclosure or the scope of the invention in any manner.

### DETAILED DESCRIPTION OF SPECIFIC EMBODIMENTS

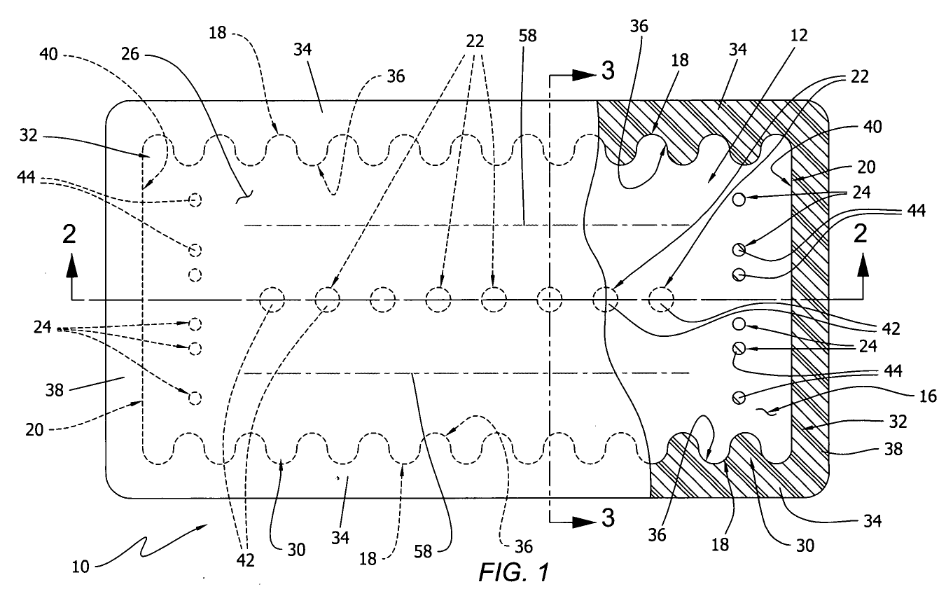

Referring initially to FIGS. 1-3, there is illustrated a laminated panel-like structure, generally designated by the numeral 10, and constructed in accordance with the principles of the present invention. The laminated structure 10 includes an inner metal layer 12 and a pair of opposite outer plastic layers 14. Preferably, but not necessarily, the metal is stainless steel and the plastic is ultra-high molecular weight polyethylene (UHMWPE) plastic material.

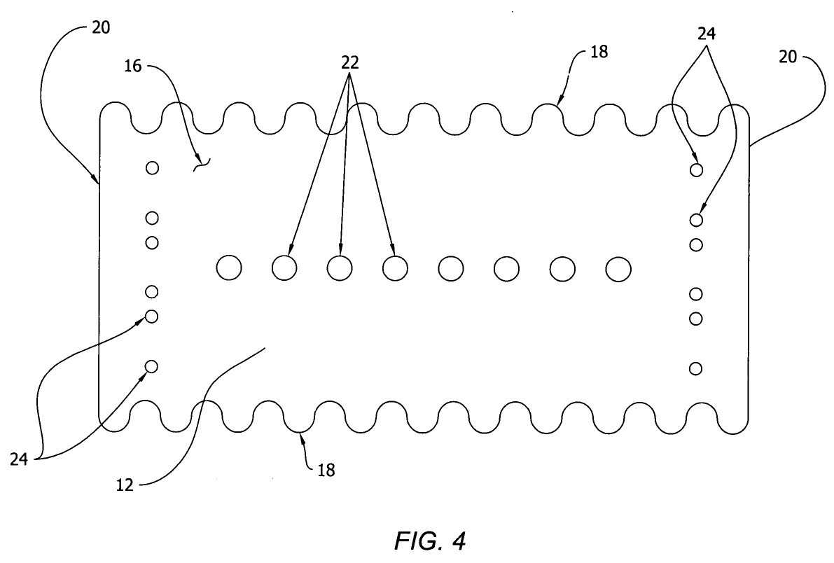

Metal layer 12 includes opposite surfaces 16, a pair of opposite longitudinal edges 18 and a pair of opposite end edges 20 extending generally transverse to the longitudinal edges 18. Metal layer 12 further includes a plurality of generally longitudinally aligned holes 22 which extend through the metal layer between opposite surfaces 16 and which are generally aligned with longitudinal edges 18. Longitudinal holes 22 are preferably centrally located equidistant from longitudinal edges 18 as best seen in FIGS. 1 and 4. Metal layer 12 is further provided with a plurality of end edge holes 24 which extend through the metal layer between the opposite surfaces 16 and which are disposed generally adjacent the end edges 20 and transverse to the longitudinal edges 18.

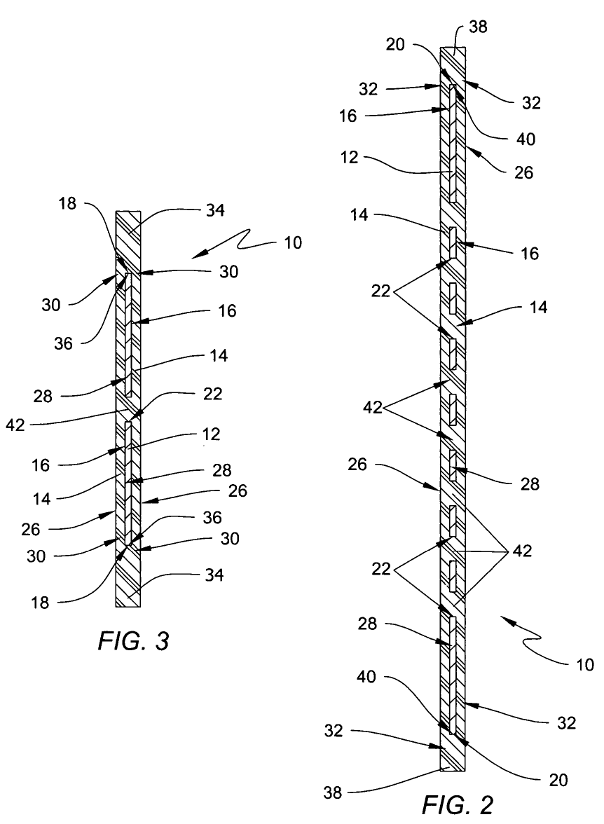

The outer plastic layers 14 each include an outer surface 26 and an inner surface 28. Plastic inner surfaces 28 are located adjacent each of the opposite metal surfaces 16. Plastic layers 14 each further include a pair of longitudinal edges 30 disposed generally adjacent the longitudinal edges 18 of metal layer 12 and a pair of end edges 32 disposed generally adjacent the end edges 20 of metal layer 12. As best seen in FIG. 3, plastic longitudinal edges 30 are joined to one another with a plastic longitudinal edge portion 34. Longitudinal edge portion 34 is preferably integrally formed with plastic longitudinal edges 30 and, further, preferably fully encloses the longitudinal edges 18 of metal layer 12. The plastic longitudinal edge portions 34 each further include a plastic longitudinal inner edge 36 located adjacent its respective longitudinal edge 18 of metal layer 12. As best seen in FIG. 2, plastic end edges 32 are joined to one another with a plastic end edge portion 38. End edge portion 38 is preferably integrally formed with plastic end edges 32 and, further, preferably encloses the end edges 20 of metal layer 12. The plastic end edge portions 38 each further include a plastic inner edge 40 located adjacent its respective end edge 20 of metal layer 12.

As should now be appreciated, the plastic inner edges 40 of the end portions 38 and the metal end edges 20 are adjacent one another or have a common mating configuration and, as shown, are generally linear and located transverse to the longitudinal edges 18. The plastic longitudinal inner edges 36 of longitudinal edge portions 34 and the metal longitudinal edges 18 are adjacent one another or have a common mating configuration which preferably is non-linear. In the preferred embodiment of FIG. 1, the common mating non-linear configuration between the longitudinal edge portions 34 and the metal longitudinal edges 18 is sinusoidally shaped as shown. Other common mating configurations between the plastic longitudinal edge portions 34 and the metal longitudinal edges 18 at respective plastic longitudinal inner edge 36 and metal longitudinal edge 18 can include, for example, a square wave shape configuration as shown in FIG. 8 and a triangular wave shape configuration as shown in FIG. 9. As more fully described hereinbelow, such non-linear configurations between the longitudinal edge portions 34 and the longitudinal edges 18 of metal layer 12 provide for and allow the plastic longitudinal inner edge 36 to separate from the metal longitudinal edge 18 as a result of compressive and tensile forces created in the metal layer 12 and plastic layers 14 after bending the laminated structure 10 into a channel while, nevertheless, maintaining the longitudinal edge portion 34 generally straight and coplanar with the metal layer 12 and plastic layers 14 along the longitudinal edges of the laminated structure 10. More importantly, the longitudinal plastic edge portions 34 and end edge portions 38 maintain the outer plastic layers 14 adjacent the metal layer 12 prior to, during and after the bending of the laminated structure 10 so as to form channels as may be desired.

So as to further maintain or pin the plastic layers 14 to the metal layer 12 prior to, during and after bending the laminated structure 10 into a channel, plastic portions 42 are provided in the longitudinally-aligned holes 22 and plastic portions 44 are provided in the end edges holes 24. Plastic portions 42 and 44 are preferably integrally formed with plastic layers 14 extending through and filling their respective holes 22 and 24 thereby retaining the outer plastic layers 14 adjacent the metal layer 12.

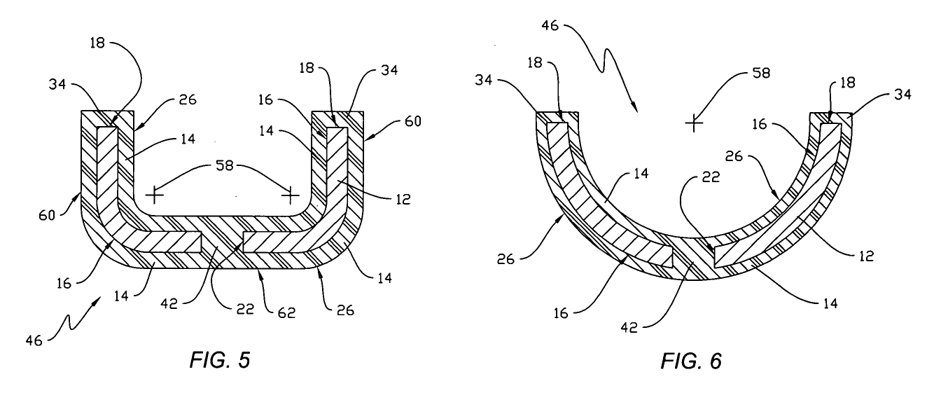

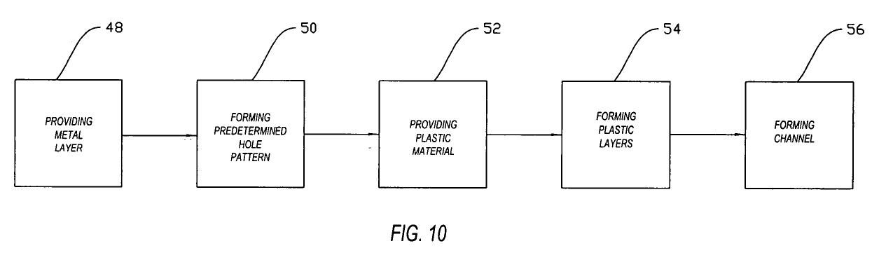

As illustrated in the block diagram of FIG. 10, the panel like laminated structures 10 are formed or bent so as to form laminated channels having a desired cross sectional shape as, for example, shown and generally designated by the numeral 46 in FIGS. 5-7. The fabrication process, in general, comprises the steps of: providing a metal sheet or layer 12, as per block 48; forming a pre-determined pattern of holes such as the row of longitudinally aligned holes 22 and end edges holes 24 through the metal layer 12, as per block 50; providing a plastic material on the metal opposite surfaces 16 and within the holes 22 and 24 and also along the metal opposite longitudinal edges 18 and opposite end edges 20, as per block 52; forming the plastic material into the plastic layers 14 on the metal opposite surfaces 16 and simultaneously integrally forming the plastic portions 42 and 44 within respective holes 22 and 24 and also simultaneously integrally forming the plastic longitudinal edge portions 34 and end portions 38 thereby pinning and maintaining the plastic layers 14 on the metal layer 12 and thereby forming the laminated structure 10, as per block 54; and, forming a channel 46 by bending the laminated structure 10 about one or more bend axes 58 which are generally parallel with the longitudinal edges 18 and aligned holes 22 so as to form channels 46 of a desired cross sectional shape, as per block 56.

More particularly, the metal layer 12 is preferably stainless steel in a sheet form as shown and holes 22 and 24 are created by stamping equipment for thereby quickly and efficiently providing the holes 22 and 24 in a predetermined pattern as, for example, shown in FIGS. 1 and 4. The metal longitudinal edges 18 and end edges 20 are also cut preferably in a stamping operation so as to properly size the metal layer 12 and to also provide the non-linear longitudinal edge 18 which, as described hereinabove, may include a sinusoidal, triangular and/or square wave configuration. After the metal layer 12 holes and edges have been cut and/or formed as desired, metal layer 12 is loaded into a compression mold along with a plastic resin, preferably UHMWPE, such that the metal layer 12 is encapsulated within the resin and the resin flows into the holes 22 and 24 and around the perimeter edges 18 and 20. The mold is then subjected to a preselected elevated heat and pressure level, well known to those of ordinary skill in the art, so as to consolidate the plastic resin into a plastic and thereby integrally forming the plastic layers 14, longitudinal edges 34, end edges 38 and holes portions 42 and 44. The plastic layers 14 and metal layer 12 do not have a chemical bond formed between them and, thus, plastic layers 14 are disposed in a movably slidable relationship relative to and adjacent opposing metal surfaces 16 and plastic inner surfaces 28. Plastic layers 14 are, however, maintained adjacent the metal layer 12 via the plastic portions 42 and 44 extending through holes 22 and 24 and longitudinal edge portions 34 and end edge portions 38. Accordingly, plastic layers 14 are interconnected and are mechanically fastened to one another without chemical bonding.

The forming of metal and plastic layers 12 and 14 of laminated structure 10 into channels 46 is performed using equipment and/or devices such as a break press, roll forming equipment, hand bending or with other suitable bending or forming equipment capable of bending the laminated structure 10 along one or more longitudinal axes 58 extending generally parallel with longitudinally aligned holes 22 and longitudinal edges 18. The UHMWPE plastic characteristics are such that the plastic layers 14 will not maintain a channel shape when bent. On the other hand, metal has a memory characteristic such that metal layer 12 will maintain a channel shape after bending. In this regard, metal layer 12 is sized sufficiently thick and has sufficient memory and stiffness after bending so that it will also maintain the plastic layers 14 in the desired channel shape 46.

During the bending or otherwise forming of the channel 46, the plastic layer 14 on the inside or interior surface of the laminated channel is generally placed in compression, whereas the plastic layer 14 on the exterior or outside surface of the channel is placed in tension. Nevertheless, both during and after the bending process the plastic layers 14 are maintained adjacent to the metal layer 12. In this regard, longitudinally aligned holes 22 are preferably centrally located equidistant from metal edges 18 as shown such that very little, if any, compressive and/or tensile forces are experienced by the plastic portions 42 and the metal there around forming the respective holes 22. Between longitudinally aligned holes 22 and longitudinal edges 18, plastic layers 14 and the metal layer 12 will shift and slidably move relative to one another and depending on the overall shape of the channel 46 being formed. Furthermore, longitudinal metal edges 18 may also separate from the plastic longitudinal inner edges 36. However, the non linear configuration maintains the plastic longitudinal edge portions 34 generally aligned or parallel with the metal layer 12 and plastic layers 14 at their longitudinal edges. Additionally, it has been found that the mechanical fastening of plastic layers 14 to metal layer 12 as shown effectively prevents separation thereof after bending and forming channels 46 or, more particularly, maintaining plastic inner surfaces 28 adjacent the metal surfaces 16.

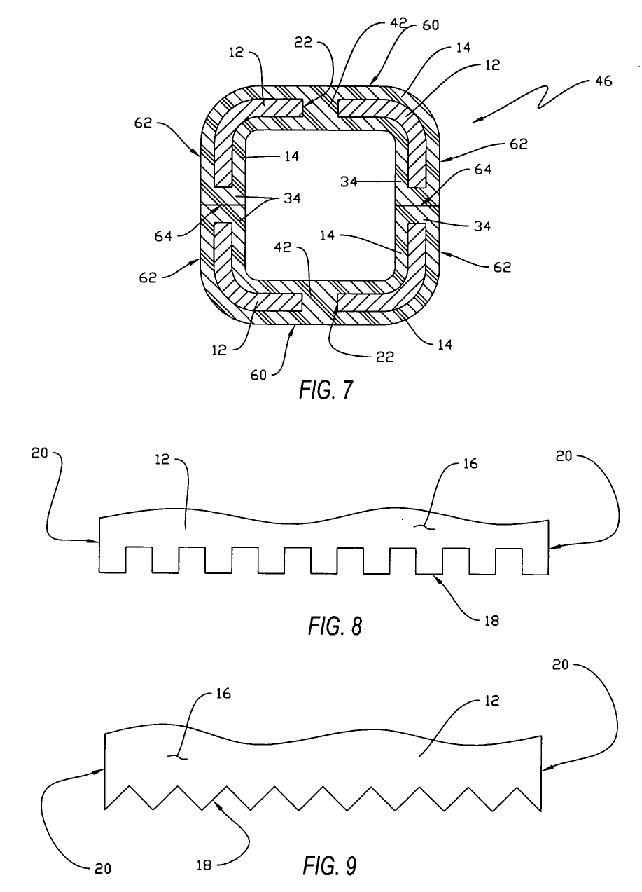

Examples of channel shapes 46 are shown in FIGS. 5-7. The channel 46 of FIG. 5 is U-shaped and includes a pair of sides 60 bent 90 degrees relative to base 62 about bend axes 58. The channel 46 of FIG. 6 is semi-circular shaped wherein the laminated structure 10 is continuously bent around bend axis 58. The channel 46 of FIG. 7 is tubular and is formed by bending two channel 46 as shown in FIG. 5 and joining them at their longitudinal edge portions 34 along joinder lines 64. Additional cross-sectional or bent channel shapes include V-shape and cylindrical.

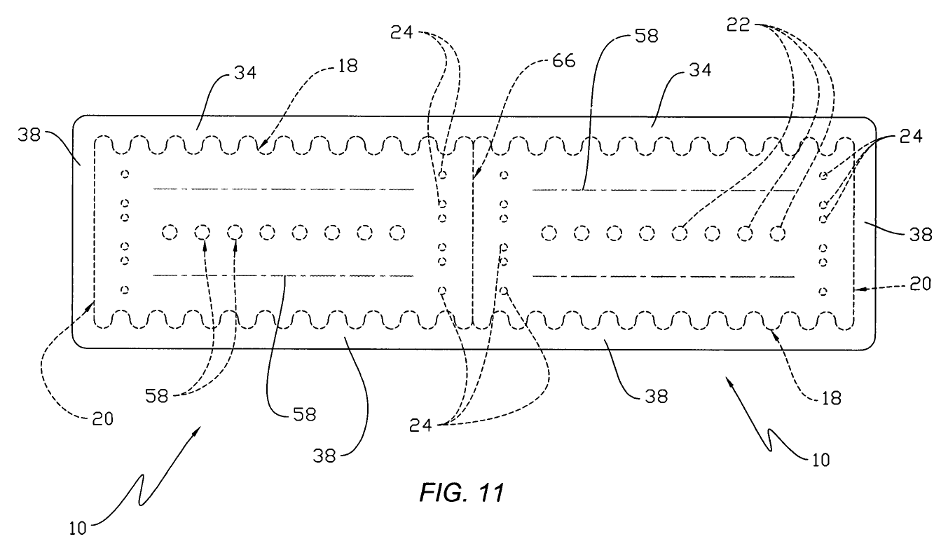

If the desired overall length of channel 46 is to be longer than the longitudinal length of laminate structure 10, two or more laminate structures 10 can be joined end-to end as shown in FIG. 11. Joining of the laminated structures 10 together is accomplished by removing the plastic end edge portions 38 to expose the metal end edges 20 of the structures 10 and then fastening the edges 20 of the metal together such as by butt welding, bolting or the like along end edge attachment line 66. The plastic layers 14 are thereafter preferably also attached to one another end-to-end, also along attachment line 66, thereby again encapsulating the metal layers 12 with the plastic layers 14. It is noted that plastic layers 14 are effectively prevented from separating along the lamination ends during and after such end-to-end joining by the interconnection of plastic layers 14 with plastic portions 44 extending through end edge holes 24. Although joining of the laminated panels can occur prior to bending for forming the desired channel shape, it is preferred that the laminated panels or structures 10 first be bent into a desired common channel shape and that such bent channels, thereafter, be joined as needed end-to-end so as to form the longer desired length channel.

It is noted that the holes 22 and 24 in metal layer 12 can be of any suitable shape, such as circular or polygonal (triangular, square, etc.), and are spaced from one another and provided in such predetermined pattern at selected locations on the metal layer 12 in accordance with the particular cross-sectional shape desired for a finished product, such as a laminated channel 46. Enough holes must be provided to properly pin and maintain the metal and plastic layers 12 and 14 together during and after bending and/or joining while preventing undue stresses such that the metal and plastic layers could separate.

While the invention has been described as having specific embodiments, it will be understood that it is capable of further modification. This application is, therefore, intended to cover any variations, uses or adaptations of the invention following the general principles thereof and including such departures from the present disclosure as come within known or customary practice in the art to which this invention pertains and fall within the limits of the appended claims.

1. A laminated channel, comprising:
(a) an inner metal layer having opposite surfaces and a pair of opposite longitudinal edges;
(b) outer plastic layers adjacent each said opposite surfaces of said inner metal layer, said plastic layers each having a pair of longitudinal edges disposed adjacent said longitudinal edges of said inner metal layer and wherein, at each longitudinal edge of said inner metal layer, said plastic layers longitudinal edges are joined to one another with a plastic edge portion; and,
(c) said inner metal layer and outer plastic layers being bent together between said metal longitudinal edges for thereby forming said laminated channel, and wherein said plastic edge portion between said plastic layers longitudinal edges maintain said outer plastic layers adjacent said metal layer during and after said bending.

2. The laminated channel of claim 1 wherein said longitudinal edges of said inner metal layer and said plastic edge portions have a common mating non-linear configuration.

3. The laminated channel of claim 1 wherein said longitudinal edges of said inner metal layer and said plastic edge portions have a common mating sinusoidal shape.

4. The laminated channel of claim 1 wherein said longitudinal edges of said inner metal layer and said plastic edge portions have a common mating square wave shape.

5. The laminated channel of claim 1 wherein said longitudinal edges of said inner metal layer and said plastic edge portions have a common mating triangular wave shape.

6. The laminated channel of claim 1 wherein said inner metal layer is comprised of stainless steel.

7. The laminated channel of claim 1 wherein said outer plastic layers and said plastic edge portions are comprised of ultra-high molecular weight polyethylene.

8. The laminated channel of claim 1 wherein said laminated channel is bent so as to have a U-shape in cross section.

9. The laminated channel of claim 1 wherein said laminated channel is bent so as to have a tubular shape in cross section.

10. The laminated channel of claim 1 wherein said laminated channel is bent so as to have a V-shape in cross section.

11. The laminated channel of claim 1 wherein said laminated channel is bent so as to have a semicircular shape in cross section.

12. The laminated channel of claim 1, further comprising:
(a) at least one hole extending through said metal layer between said opposite surfaces;
(b) said outer plastic layers joined to one another with a plastic portion extending through said hole in said inner metal layer such that said outer plastic layers are retained adjacent said inner metal layer; and,
(c) wherein said plastic portion extending through said hole maintains said outer plastic layer adjacent said metal layer during and after said bending.

13. The laminated channel of claim 12, wherein a plurality of holes are provided through said metal layer between said opposite surfaces, said holes substantially aligned in a row generally parallel to said longitudinal edges, and wherein said outer plastic layers are joined to one another with plastic portions extending through said plurality of holes.

14. The laminated channel of claim 13, wherein said inner metal layer further includes a pair of opposite end edges extending generally transverse to said longitudinal edges, said plastic layers each further having a pair of end edges disposed adjacent said end edges of said inner metal layer and wherein, at each end edge of said inner metal layer, said plastic layers end edges are joined to one another with a plastic edge portion.

15. The laminated channel of claim 14 wherein said end edges of said inner metal layer are enclosed by said outer plastic layers and said plastic edge portion.

16. The laminated channel of claim 14, wherein generally adjacent each said opposite end edges of said metal layer a plurality of holes are provided through said metal layer between said opposite surfaces and wherein said outer plastic layers are joined to one another with plastic portions extending through said plurality of holes adjacent said opposite end edges of said metal layer.

17. The laminated channel of claim 16, wherein a pair of channels are aligned and joined to one another end to end along their respective end edges thereby forming a longer channel.

18. The laminated channel of claim 16, wherein a pair of channels are aligned side by side and joined to one another longitudinal edge to longitudinal edge thereby forming a channel having a tubular shape in cross section.

19. The laminated channel of claim 16 wherein said longitudinal edges of said inner metal layer and said plastic edge portions have a common mating non-linear configuration.

20. The laminated channel of claim 19 wherein said outer plastic layers and said plastic edge portions are comprised of ultra-high molecular weight polyethylene.

21. The laminated channel of claim 16 wherein said outer plastic layers and said plastic edge portions are comprised of ultra-high molecular weight polyethylene.

22. The laminated channel of claim 1, wherein said inner metal layer further includes a pair of opposite end edges extending generally transverse to said longitudinal edges, said plastic layers each further having a pair of end edges disposed adjacent said end edges of said inner metal layer and wherein, at each end edge of said inner metal layer, said plastic layers end edges are joined to one another with a plastic edge portion.

23. The laminated channel of claim 22 wherein said end edges of said inner metal layer are enclosed by said outer plastic layers and said plastic edge portion and said longitudinal edges of said inner metal layer are enclosed by said outer plastic layers and said plastic edge portion.

24. The laminated channel of claim 22, wherein generally adjacent each said opposite end edges of said metal layer a plurality of holes are provided through said metal layer between said opposite surfaces and wherein said outer plastic layers are joined to one another with plastic portions extending through said plurality of holes adjacent said opposite end edges of said metal layer.

25. The laminated channel of claim 24 wherein said end edges of said inner metal layer are enclosed by said outer plastic layers and said plastic edge portion and said longitudinal edges of said inner metal layer are enclosed by said outer plastic layers and said plastic edge portion.

26. The laminated channel of claim 1 wherein whereby said longitudinal edges of said inner metal layer are enclosed by said outer plastic layers and said plastic edge portion.

27. A laminated channel, comprising:
(a) an inner metal layer having opposite surfaces, and at least one hole extending through said metal layer between said opposite surfaces;
(b) outer plastic layers adjacent each said opposite surfaces of said inner metal layer, said outer plastic layers joined to one another with a plastic portion extending through said hole in said inner metal layer such that said outer plastic layers are retained adjacent said inner metal layer; and,
(c) said inner metal layer and outer plastic layers being bent together for thereby forming said laminated channel and wherein said plastic portion extending through said hole maintains said outer plastic layer adjacent said metal layer during and after said bending.

28. The laminated channel of claim 27, wherein said metal layer includes longitudinal edges and a plurality of holes are provided through said metal layer between said opposite surfaces, said holes substantially aligned in a row generally parallel to said longitudinal edges, and wherein said outer plastic layers are joined to one another with plastic portions extending through said plurality of holes.

29. The laminated channel of claim 28, wherein generally adjacent each said opposite end edges of said metal layer a plurality of holes are provided through said metal layer between said opposite surfaces and wherein said outer plastic layers are joined to one another with plastic portions extending through said plurality of holes adjacent said opposite end edges of said metal layer.

30. The laminated channel of claim 29 wherein said outer plastic layers and said plastic edge portions are comprised of ultra-high molecular weight polyethylene.

31. A laminated channel, comprising:
(a) an inner metal layer having a pair of opposite surfaces, a pair of opposite longitudinal edges, a pair of opposite end edges extending in a generally transverse relationship to said longitudinal edges, and a predetermined pattern of holes located in said inner metal layer in at least one row in which said holes are spaced apart from one another in said row and from said longitudinal edges and extend in a generally transverse relationship to said opposite end edges;
(b) outer plastic layers having a pair of longitudinal edges disposed adjacent said longitudinal edges of said inner metal layer and a pair of end edges disposed adjacent said end edges of said inner metal layer, said outer plastic layers being disposed in movably slidable relationship relative to and on said opposite surfaces of said inner metal layer, said outer plastic layers having portions extending through said holes of said row thereof in said inner metal layer such that said portions interconnect said outer plastic layers to one another and pin said outer plastic layers to said inner metal layer at said locations of said holes so that said outer plastic layers are immovable relative to said inner metal layer along said row of holes; and,
(c) said inner metal layer and outer plastic layers being bent together along at least one longitudinal axis extending between said opposite ends of said inner metal layer and outer plastic layers and spaced from and generally parallel to said row of holes and said longitudinal edges of said inner metal layer and outer plastic layers so as to provide said laminated channel with a preselected cross-sectional shape.

32. A method of fabricating a laminated channel, comprising the steps of:
(a) providing a metal layer having a pair of opposite surfaces, a pair of opposite longitudinal edges, and a pair of opposite end edges extending in a generally transverse relationship to said longitudinal edges;
(b) forming a predetermined pattern of holes in said metal layer in at least one row thereof in which said holes are spaced apart from one another in said row and from said longitudinal edges and said at least one row of holes extend in a generally transverse relationship to said opposite end edges;
(c) providing a plastic material on said opposite surfaces of said metal layer;
(d) forming said plastic material into plastic layers on said opposite surfaces of said metal layer such that said plastic layers are disposed in movably slidable relationship along said opposite surfaces of said metal layer and have a pair of longitudinal edges disposed adjacent said longitudinal edges of said metal layer and a pair of end edges disposed adjacent said end edges of said metal layer but also such that portions of said plastic layers extend through said holes of said row thereof in said metal layer so as to interconnect said plastic layers to one another and pin said plastic layers to said metal layer at the locations of said holes so that said plastic layers are immovable relative to said metal layer along said row of holes; and
(e) forming said channel by bending said metal and plastic layers together along at least one longitudinal axis extending between said opposite ends of said metal and plastic layers and spaced from and generally parallel to said row of holes and said longitudinal edges of said metal and plastic layers.

33. The method of claim 32 further comprising the step of forming said longitudinal edges of said metal and plastic layers with a common non-linear configuration.

34. The method of claim 32 wherein said providing said metal layer includes providing a stainless steel metal layer.

35. The method of claim 32 wherein said providing said plastic layers includes providing ultra-high molecular weight polyethylene plastic layers.

36. The method of claim 32 further comprising the step of providing said metal layer with at least another row of holes extending generally parallel to and spaced from one of said end edges thereof which enables end portions of said plastic layers to interconnect one another and pin with said metal layer through said another row of holes so as to prevent separation of said layers adjacent said end edges of said layers.

37. The method of claim 32 further comprising the step of forming plastic material longitudinal edge portions interconnecting said plastic layers longitudinal edges.

38. The method of claim 37 further comprising the step of forming plastic material end edge portions interconnecting said plastic layers end edges.
